(19) United States
(12) Patent Application Publication
(10) Pub. No.: US 2026/0084561 A1
(43) Pub. Date: Mar. 26, 2026

(54) ROTATABLE CHARGING SYSTEM

(71) Applicant: VOLTPOST, INC., New York, NY (US)

(72) Inventors: Chiraag M. HEBBAR, San Francisco, CA (US); Jason Yuuki Miyata WOODRUFF, Oakland, CA (US); Joern VICARI, San Francisco, CA (US); Alejandro Enrique VALLEJO, Oakley, CA (US)

(21) Appl. No.: 19/111,012

(22) PCT Filed: Sep. 12, 2023
(86) PCT No.: PCT/US2023/032563

§ 371 Date: Mar. 12, 2025

Related U.S. Application Data
(60) Provisional application No. 63/375,339, filed on Sep. 12, 2022.

(51) Int. Cl. B60L 53/31; B60L 53/16

(52) U.S. Cl. CPC B60L 53/31; B60L 53/16

(57) ABSTRACT

A system having a rotating front plate defining a charge port, a motor configured to provide powered rotational movement, and a rotation assembly configured to rotate the rotating front plate using the motor. The rotating front plate is configured to rotate between a first position and a second position. The first position can be 180°from the second position.

### CROSS REFERENCE TO RELATED APPLICATIONS

This application claims priority to U.S. Provisional Application No. 63/375,339, filed on Sep. 12, 2022, the disclosure of which is incorporated herein by reference.

### FIELD OF DISCLOSURE

This disclosure relates to electric vehicle (EV) charging systems.

### BACKGROUND OF THE DISCLOSURE

Greenhouse gases (GHG) are responsible for the increasing temperature throughout the last decade. Temperature rise at this level generates dangerous impacts to environmental ecosystems that threaten human survival. Transportation accounts for 31% of GHG emissions across the United States. Globally, transportation is 16% of total emissions, and internal combustion engine light-duty vehicles are the largest source of these emissions.

Currently about 2% of total cars across the United States are electric. Installing reliable access to charging stations on residential city streets, rather than just in central locations such as shopping malls, is critical to increase adoption. According to the U.S. Department of Energy, over 80% of EV charging happens at home. However, the majority of city cars park on the street. Although many city residents want to purchase EVs, the top adoption barrier is the lack of public charging stations, which causes range anxiety. Convenient public charging access is needed for drivers without garages.

Therefore, an improved charging system is needed, which can be implemented on city streets. The charging system must allow for proper storage of the charging equipment.

### SUMMARY OF THE DISCLOSURE

The present disclosure provides a system having a rotating front plate defining a charge port, a motor configured to provide powered rotational movement, and a rotation assembly configured to rotate the rotating front plate using the motor. The rotating front plate may be configured to rotate between a first position and a second position, and the first position may be 180° from the second position.

In an embodiment of the present disclosure, the system may further include a charge plug having a charge handle.

In an embodiment, the charge plug may be configured to be retained in the charge port.

In an embodiment of the present disclosure, the first position may be configured to enable the storage of the charge plug, and the second position may be configured to enable use of the charge plug.

In an embodiment of the present disclosure, the charge handle may be locked in the first position and unlocked in the second position.

In an embodiment of the present disclosure, the rotating front plate may be disposed on a stationary body.

In an embodiment of the present disclosure, the charge handle may be configured to be positioned toward a top end of the stationary body when in the first position and the charge handle may be configured to be positioned towards a bottom end of the stationary body when in the second position.

In an embodiment of the present disclosure, the system may further include a bearing. The bearing may include ball bearings and ball bearing rails configured to allow for rotational movement of the rotating front plate.

In an embodiment of the present disclosure, the system may further include a processor in electronic communication with the motor.

In an embodiment, the system may further include an encoder to determine rotation of the rotating front plate.

In an embodiment, the system may include a sensor to determine when the charge handle is disposed in the charge port.

Further, the present disclosure provides a method including rotating a rotating front plate and a charge handle of a charge plug from a first position to a second position and from the second position to the first position using a motor with a rack and pinion assembly or another mechanism.

In an embodiment of the present disclosure, the first position is 180°from the second position.

In an embodiment of the present disclosure, a user may rotate the rotating front plate between the first position and the second position manually.

In an embodiment of the present disclosure, the motor may prevent rotation of the rotating front plate when not activated.

In an embodiment of the present disclosure, the first position may be configured to enable the storage of the charge plug, and the second position may be configured to enable use of the charge plug.

In an embodiment of the present disclosure, the charge handle may be locked in the first position and unlocked in the second position.

In an embodiment of the present disclosure, a processor may be configured to provide instructions to the motor.

In an embodiment of the present disclosure, a user may rotate the rotating front plate between the first position and the second position by sending a command to the processor with a communication device.

In an embodiment of the present disclosure, a non-transitory computer readable medium storing a program may be configured to instruct a processor to execute the method disclosed herein.

### BRIEF DESCRIPTION OF THE FIGURES

For a fuller understanding of the nature and objects of the disclosure, reference should be made to the following detailed description taken in conjunction with the accompanying figures.

FIG. 1 is a perspective view of the front of a system in accordance with the present disclosure, wherein the plug and handle are shown in phantom;

FIG. 2 is a front view of a charging station with the system of FIG. 1 in a first position;

FIG. 3 is a front view of a charging station with the system of FIG. 1 in a second position;

FIG. 4 is a partial section view of the system of FIG. 1;

FIG. 5 is a front view of the system of FIG. 1;

FIG. 6 shows rotation from the front of the system of FIG. 1;

FIG. 7 shows rotation from the rear of the system of FIG. 1;

FIG. 8 is a partial section view of another embodiment of the system of FIG. 1 along A-A of FIG. 9;

FIG. 9 is a front view of a charging station with the system of FIG. 1 corresponding to FIG. 8;

FIGS. 10 and 11 show a locking mechanism and associated cross-section in a locked position;

FIGS. 12 and 13 show a locking mechanism and associated cross-section in an unlocked position with a charge handle; and

FIGS. 14 and 15 show a locking mechanism and associated cross-section in a locked position without a charge handle.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

The steps of the method described in the various embodiments disclosed herein are sufficient to carry out the methods of the present invention. Thus, in an embodiment, the method consists essentially of a combination of the steps of the methods disclosed herein. In another embodiment, the method consists of such steps.

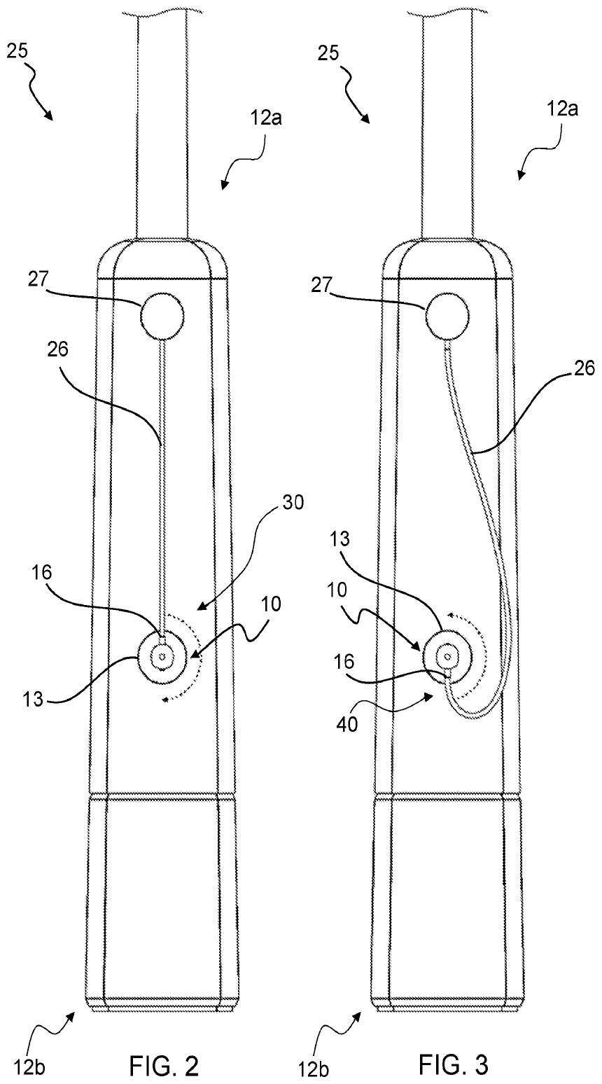

The present disclosure provides a system 10 including a rotating front plate 13 defining a charge port 14, a motor 22 configured to provide powered rotational movement, a rotation assembly configured to rotate the rotating front plate 13 using the motor 22 between a first position 30 and a second position 40 (FIGS. 2 and 3). In an embodiment, the first position 30 is 180° from the second position 40. In an embodiment, the system 10 may further include a bearing with ball bearings 17 and ball bearing rails 18, a slip bearing, or another bearing configured to allow for rotational movement of the rotating front plate 13. The motor 22 may be configured to transmit rotational movement to the rotating structures retained by the bearing. The system 10 may include associated control logic to control when the charge port 14 of the rotating front plate 13 is rotated in a particular direction.

While disclosed as a 180° rotation, other amounts of rotation are possible. The rotation assembly can rotate either clockwise or counterclockwise. This may prevent the cable from becoming tangled.

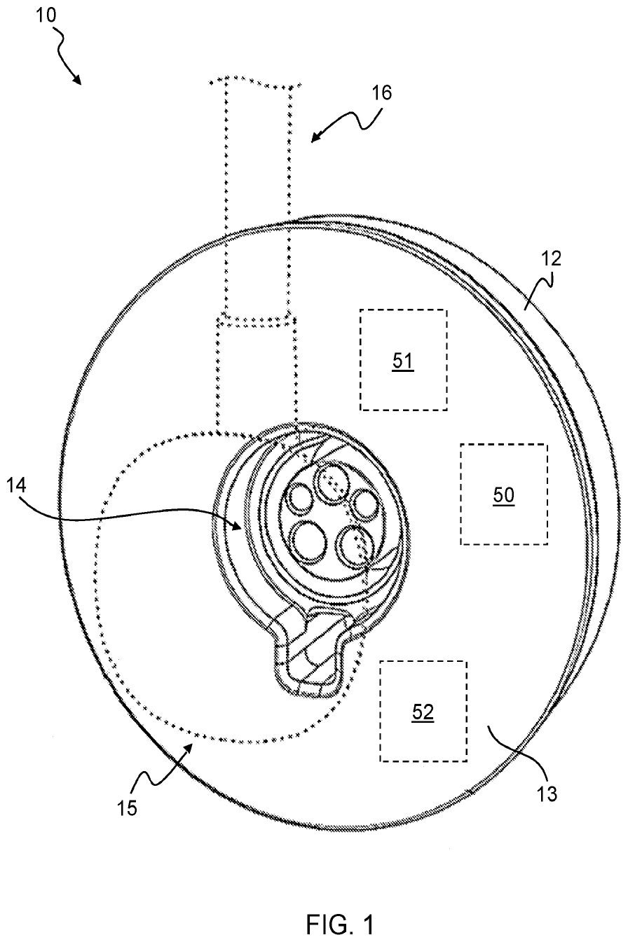

FIG. 1 is a perspective view of an embodiment of the system 10. In an embodiment, the system 10 includes a stationary body 12, which can be part of or connected to a charging station 25 (as shown in FIGS. 2 and 3). The rotating front plate 13 is connected to the stationary body 12. The rotating front plate 13 can be on the exterior of the stationary body 12 or otherwise facing a user. A charge port 14 is disposed in the rotating front plate 13, and optionally, disposed in the stationary body 12. A charge plug 15 and a charge handle 16 of the charge plug 15 are both shown in phantom. The charge plug 15 can be inserted into the charge port 14. The charge port 14 can include a seal to provide waterproof protection to the internal receiving mechanism.

In an embodiment, the charge port 14 can be configured to lock the charge plug 15 and the charge handle 16 in place. The charge port 14 can include a detent or other mechanisms configured to lock a latch on the charge plug 15. This can prevent the charge plug 15 from being pulled out of the charge port 14. An additional locking mechanism can optionally be used to prevent unlocking the charge plug 15 while in the first position 30. For example, this can be a solenoid located above the latch and behind a tooth position. When actuated, it is not possible for the latch to clear the detent and be extracted.

FIG. 2 is a front view of an embodiment of system 10 in a first position 30 wherein the stationary body 12 is part of a charging station 25. In this embodiment, the rotating front plate 13 is in the first position 30. While the rotating front plate 13 is in the first position 30, the charge plug 15 and the charge handle 16 are in a non-rotated position, and the charge handle 16 is configured to be positioned towards a top end 12a of the stationary body 12 that may be part of the charging station 25. In the first position 30, the charge port 14 is upside-down, which enables storage of the charge plug 15. This can lock the charge plug 15 in place and/or use gravity to cradle the charge plug 15 while allowing a power cable 26 attached to the charge plug 15 to be held taut relative to an overhead cable mechanism 27. The charge port 14 may face the overhead cable mechanism 27 in the first position. A latch on the charge plug 15 has a tooth that can hook onto a detent in the port. The latch can be spring-loaded and can be actuated by a user. When locked, the latch is rotated into a position where the latch cannot be activated by a user and cannot be removed from the port.

The first position 30 prevents the power cable 26 from wrapping around the charging station 25, which reduces the chance of accidents and/or damage to the system 10, the power cable 26, and the charging station 25. The first position 30 allows the power cable 26 to be positioned downwardly, which enables a user to use gravity to release the power cable 26 and to enable better tension control of the power cable 26.

FIG. 3 is a front view of an embodiment of system 10 in a second position 40 wherein the stationary body 12 is part of a charging station 25. In this embodiment, the rotating front plate 13 is in the second position 40. While the rotating front plate 13 is in the second position 40, the charge plug 15 and the charge handle 16 are in a rotated position, and the charge handle 16 is configured to be positioned toward a bottom end 12b of the stationary body 12 that may be part of the charging station 25. The charge port 14 may face away from the overhead cable mechanism 27 in the second position. In the second position 40, the charge port 14 is right-side-up, which enables use of the charge plug 15. In this position, the charge handle 16 is in a position ready for use by a user. In an embodiment, the second position is 180° from the first position, but other amounts of rotation are possible.

In an embodiment, the system 10 may be moved from the first position to the second position or from the second position to the first position manually by a user. In an embodiment, the system 10 is locked in the first position 30. The user can rotate the system 10 to the second position 40 by rotating the rotating front plate 13 by 180° or another rotation amount. While the system 10 is in the second position 40, the charge handle 16 faces downwardly to allow the user to grab the charge handle 16 to remove charge plug 15 from the charge port 14. Further, in an embodiment, the system 10 is unlocked in the second position 40. After use of the charge plug 15, the user may hold the charge handle 16 to insert the charge plug 15 into the charge port 14. After the charge plug 15 is securely inserted into the charge port 14 of the system 10, the user may rotate the system from the second position 40 to the first position 30 by rotating the rotating front plate 13 180°. The first position allows for storage of the system 10.

In an embodiment, the system 10 may be moved from the first position to the second position or from the second position to the first position by sending a command to a processor in communication with the system 10 with a communication device. The communication device may be a tablet, a phone, a computer, a vehicle, or a system within a vehicle. In an embodiment, the system 10 that is rotated to the correct orientation based on the feedback from an accelerometer or inertial measurement unit. For example, the socket can be in the correct position relative to gravity, such that it mirrors the relative orientation of the plug to the gravity vector.

Thus, the system 10 may be moved from the first position to the second position or from the second position to the first position using the motor 22. In an embodiment, the system 10 is locked in the first position 30. The motor 22 can rotate the system 10 to the second position 40 by rotating the rotating front plate 13 by 180° or another rotation amount. While the system 10 is in the second position 40, the charge handle 16 faces downwardly to allow the user to grab the charge handle 16 to remove charge plug 15 from the charge port 14. Further, in an embodiment, the system 10 is unlocked in the second position 40. After use of the charge plug 15, the user may hold the charge handle 16 to insert the charge plug 15 into the charge port 14. After the charge plug 15 is securely inserted into the charge port 14 of the system 10, the motor 22 may rotate the system from the second position 40 to the first position 30 by rotating the rotating front plate 13 180°. The first position 30 allows for storage of the system 10. The motor 22 may prevent rotation of the rotating front plate 13 when not activated. Accordingly, a user may not be able to manually move the system 10 from the first position to the second position or from the second position to the first position against the motor 22 or without activation of the motor 22.

A sensor 50 can be used to detect the charge handle 16 and/or the charge plug 15 in the charge port 14. The sensor 50 can be in electronic communication with the processor 52. The sensor 50 can use one or more of the following techniques. While reference in these sensing techniques refers to the charge handle 16, the techniques also can be applied to the charge plug 15.

In an instance, the rotation can be automated based on embedded magnets in the charge handle 16. One or more Hall Effect sensors can detect if the charge handle 16 is or is not in the charge port 14 using at least one magnet in the charge handle 16. Placing the charge handle 16 in the charge port 14 may cause automated rotation to the first position.

In an instance, the rotation can be automated based on pins in the charge handle 16. A sensor can detect if the charge handle 16 is or is not in the charge port 14 based on the connection with a pin or another electrically-conductive material disposed on or in the charge handle 16. Placing the charge handle 16 in the charge port 14 may cause automated rotation to the first position because the pin or other electrically-conductive material closes a circuit.

A button, latch, or optical sensor also may be used to automate the rotation. A pressure plate that depresses when the charge handle 16 is inserted into the charge port also can be used to automate the rotation.

The charge handle 16 can be detected by the use of a capacitive sensor, which measures the existence of the charge handle 16 by the change in either self-capacitance or mutual capacitance between the charge port 14 and the charge handle 16, which is then made of a dielectric material which produces a specific and measurable change in the capacitance.

In another embodiment, the charge handle 16 can be detected by an electromagnetic sensor, which measures a transmitted, reflected, diffracted, and/or dispersed signal. This can either be active, in such a way that electromagnetic waves are emitted by the charge port 14 that are then changed by a structure of the charge handle 16, or passive by which a change in the detected electromagnetic signal is produced by the insertion of the charge handle 16 based on some structures or materials specific to the charge handle 16. These structures can be one or more of protrusions, cavities, surface textures, matte of the surface, specularity of the surfaces, dielectric or conductive materials, and or changes in material which effect a change in the electromagnetic characteristics of the used wavelength or wavelengths. These waves can be in any one spectrum, broad-spectrum, or any combination thereof. This includes the use of visible, infrared, ultraviolet, millimeter, terahertz, or other waves to detect the presence of the charge handle 16 by measurable differences in the transmitted, reflected, diffracted, dispersed or otherwise detected signals in any electromagnetic spectrums or wavelengths.

Another embodiment uses electromagnetic waves, but measures changes in the temporal or phase characteristics of the detected signal, such that the insertion of the charge handle 16 causes a change in a periodic or polarized emission, or otherwise detected signal, such as is the case in time-of-flight sensors, that deterministically measures that the charge handle 16 is present in the charge port 14.

In an instance, these electromagnetic detection methods can be used in conjunction with meta-materials that present a change in the behavior of the detected signal. Some part or all of the charge handle 16 structure may include meta materials that alter the transmitted, reflected, diffracted, or dispersed electromagnetic signal in a deterministic manner.

For electromagnetic detection, one or more detection elements on the charge handle 16 can affect an imaging sensor to determine if the charge handle 16 is inserted.

An implementation of an electromagnetic sensor can use one or more of paint, color, a sticker, texture, matte, or specularity to detect the charge handle 16 in combination with an electromagnetic sensor. These features change the measured transmitted, reflected, diffracted, or dispersed signal.

For capacitive measurement, some or all of the charge handle 16 can be made of dielectric materials or can include a dedicated structure.

In an embodiment, acoustic sensing can be used, such that the resonant frequency of the area occupied by the charge handle 16 is measured to detect if the charge handle 16 is inserted or not. Directed acoustic sensing can be used and/or combined with a periodic signal to detect if the charge handle 16 is inserted.

Another embodiment uses one or more pieces of conductive material that are either part of the housing of the charge handle 16 or embedded therein. The conductive material can be detected through the use of inductive sensors in the charge port 14.

The correct orientation can also be detected by other techniques, such as use of optical indicators. This can be done as individual targets that demonstrate the final locked and unlocked positions and the motor moves in one direction until it finds the optical target. The optical target can be paint of a different color, a sticker, an additional part, or any other such feature that has a different color, texture, and/or specularity. The feature also can be a protrusion, cavity, and/or a combination thereof, such that a different response is generated with an optical sensor. The optical sensor may be a multi-element sensor, such that it makes an array, or optical imaging sensor. The target can also be made up of an image or other arrangement of these elements such that the position can be determined from the optical presentation of the target.

An encoder 51 can be used to detect the position of the front plate 13 relative to the rest of the system. The encoder 51 can be in electronic communication with the processor 52. The encoder 51 can use one or more of the following techniques.

In an embodiment with an optical indicator, an encoding wheel made up of alternating colors, protrusions, cavities, or openings can be used to denote the different zones or angles where the charge handle 16 is rotated to with precision. The optical sensor in this instance could be based on the transmission, reflection, or dispersion of an electromagnetic emission which is detected or measured.

In another embodiment, the position indication can be done using an inductive sensor by which the size, existence, or induced reactivity of a conductive material is measured. The conductive material can be embedded in the rotating or stationary components so that the position can be detected.

In another embodiment, the position can be inferred by the use of a capacitive sensor. The mutual or self-capacitance of target materials are measured and these target materials are placed such that the change in the detected capacitance can be used to indicate the position. The materials form a capacitance-based encoder system.

In another embodiment, the position can be determined by the use of a magnetic field sensor. The positioning of magnets can be used to detect the position. Multiple magnets, or magnets of varying apparent field strength also can be used to denote the different positions, as well as different orientations of the magnet such that the direction of the magnetic field is detected to determine the orientation and or position of the system. The magnets or sensors can be placed in the rotating or stationary portion of the system.

In another embodiment, the position can be determined through a protrusion or cavity which activates or deactivates a normally open or normally closed button, switch, or system.

In another embodiment, the position can be determined through the use of a potentiometer, rotational capacitor (rotary variable capacitor), or other rotational or linear driven device that produces a measurable resistive or capacitive difference thereby indicating orientation, position, or location of the system.

In another embodiment, the position can be determined by the use of acoustic sensing, by which a structure is included which changes the acoustic characteristics of a resonant chamber formed by the charge port 14 are measured. These structures can be one or more of a series of alternating openings, protrusions, cavities, baffles and/or acoustic absorbers, which change the resonant frequency as they rotate and can effect an acoustic encoder.

In another embodiment, the above structures are used, but the transmission, reflection, and/or dispersion of a directed acoustic signal is used to effect an acoustic encoder of a different methodology. This could be combined with a periodic signal, such that the time of flight is measured to affect an additional embodiment of an acoustic encoder.

The appropriate amount of rotation to be used can be determined by the processor, from the cloud, via a static analog logic, or driven completely by the user.

In an instance, the stationary body 12 is part of a charging station 25 that encapsulates a lamppost. The stationary body 12 may be part of any structure that may support a charging station for the charging of an electric vehicle on the street, in a parking lot, a parking garage, or a personal garage. The system and method described herein allows for proper storage of the charge plug 15 and the power cable 26 to prevent damage to the system 10 and to prevent the system 10 and the power cable 26 from blocking roadways, walkways, sidewalks, and parking spaces.

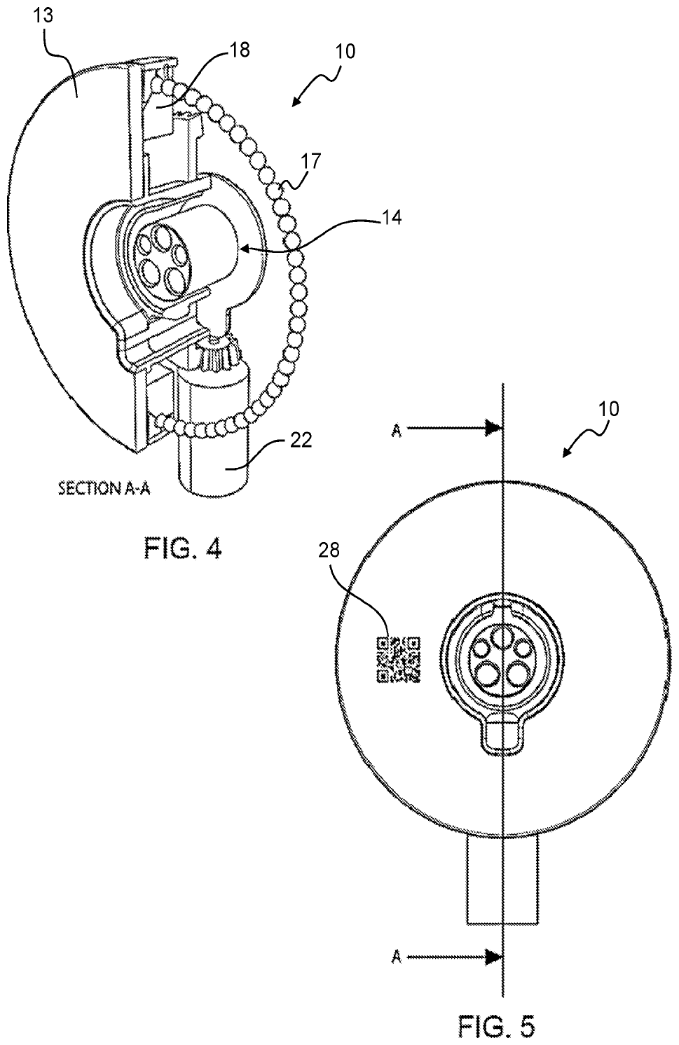

FIG. 4 is a partial section view of the system 10 of FIG. 1. This is through the section A-A shown in FIG. 5. The rotating front plate 13 can move using the ball bearings 17, but other rotation mechanisms are possible. The ball bearings 17 can be configured within a bearing assembly, which can include ball bearing rails 18. One side of the bearing assembly can be connected to the rotating front plate 13 and another side of the bearing assembly can be connected to the stationary body 12.

FIG. 5 is a front view of the system of FIG. 1. In an embodiment, a QR code 28 can be used to connect an app on a user's communication device to system 10. An app can make a charge reservation and can initiate the rotation of the system 10 so that the charge handle 16 is in the use-ready state. Thus, making the reservation can move the system from the first position 30 to the second position 40 as shown in FIGS. 2-3. After the charge plug 15 is returned into the charge port 14, the rotating front plate 13 may move back into the first position 30.

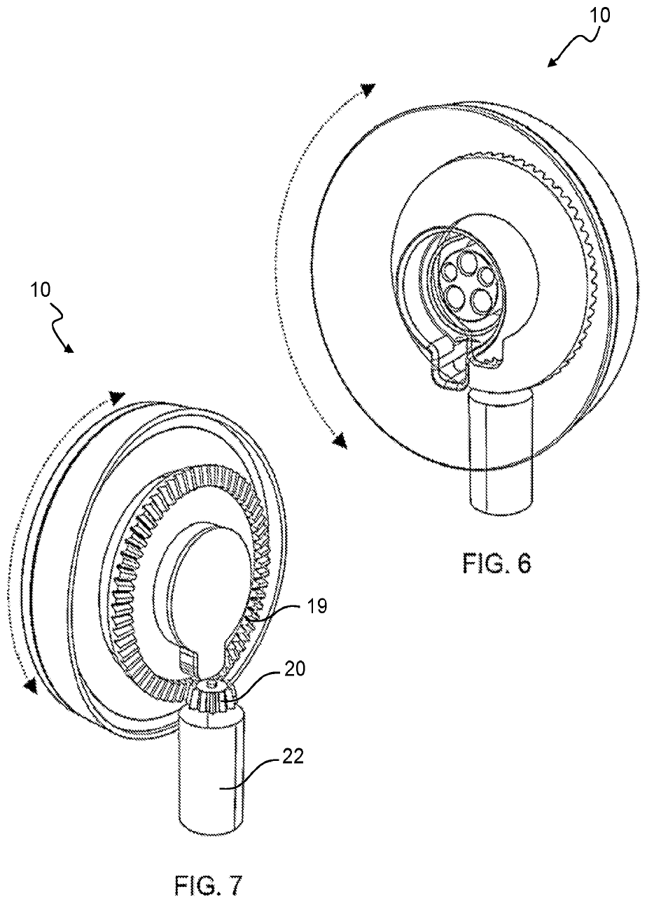

A pinion 20 can be disposed on or otherwise connected to the motor 22, which can be an electric motor, pneumatic motor, or other type of actuation system. A rack 19 can be connected to or disposed on the rotating front plate 13. The rack 19 may be a miter gear, a bevel gear, or other gear configured to engage with the pinion 20. The motor 22 can be in electronic communication with a processor 52 that provides instructions. FIG. 6 shows rotation from the front of the system of FIG. 1. FIG. 7 shows rotation from the rear of the system of FIG. 1.

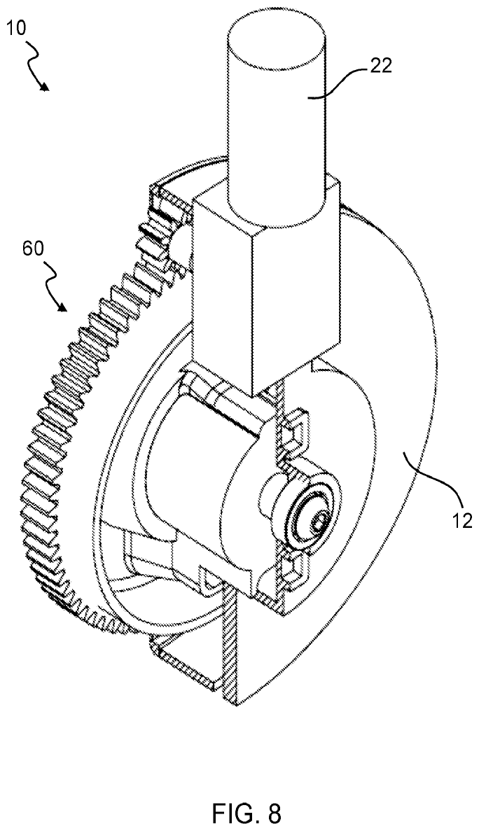

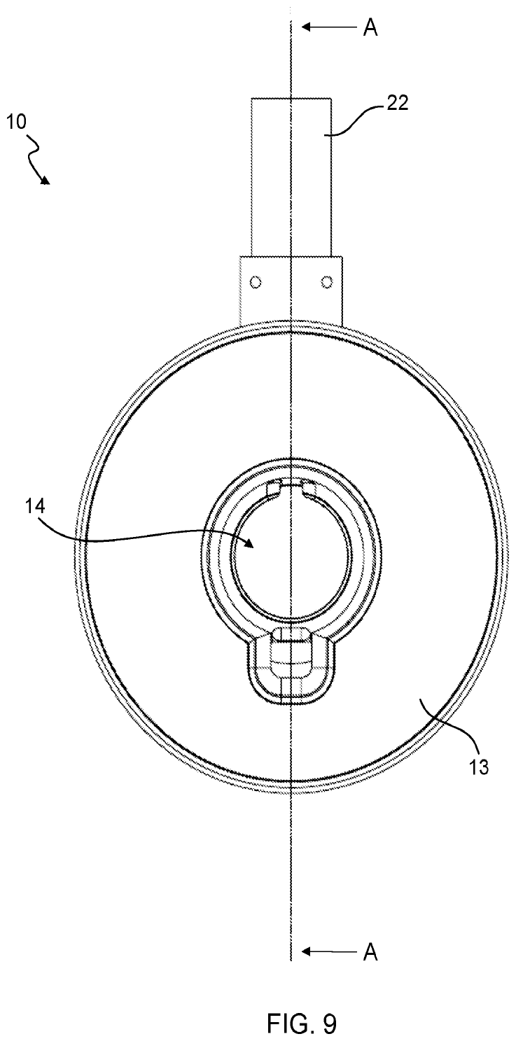

While a rack 19 and pinion 20 is disclosed, a spur gear system 60 or other types of geared systems (e.g., planetary gear system or worm gear system) are possible. Some geared systems (e.g., a worm gear system) may prevent undesired or unwanted rotation of the system 10 without activation of the motor 22. FIG. 8 is a partial section view of another embodiment of the system of FIG. 1 along A-A of FIG. 9. FIG. 9 is a front view of a charging station with the system of FIG. 1 corresponding to FIG. 8. For example, a spur gear system 60 is shown, which can be disposed on or otherwise connected to the motor 22. The spur gear system can be connected to or disposed on the rotating front plate 13. The motor 22 can be in electronic communication with a processor 52 that provides instructions.

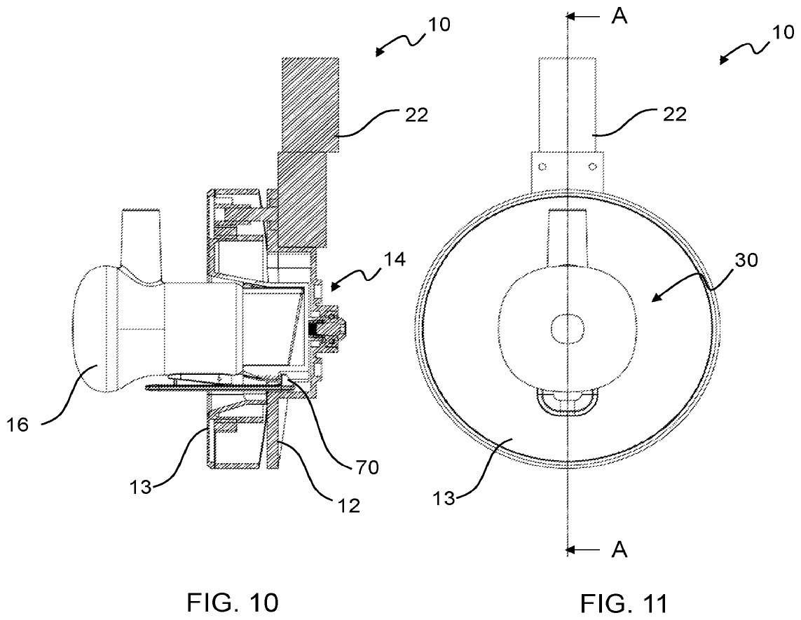

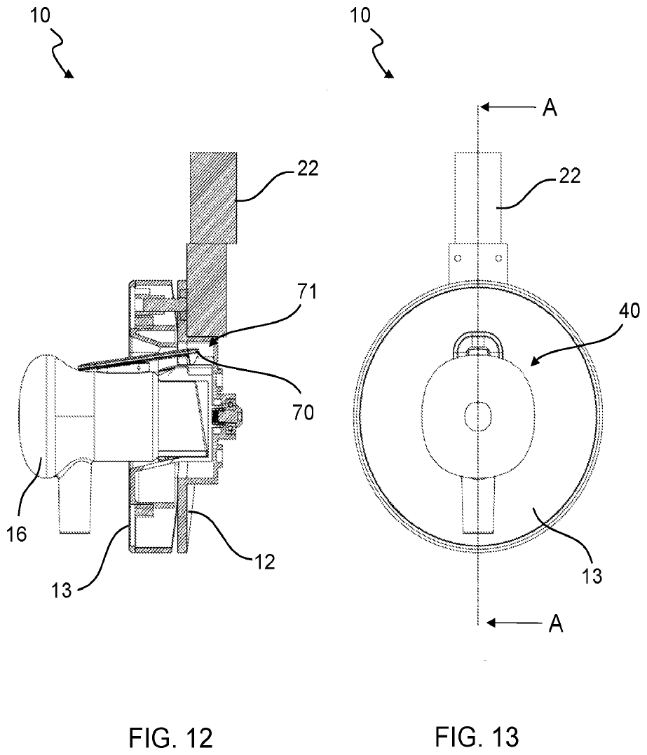

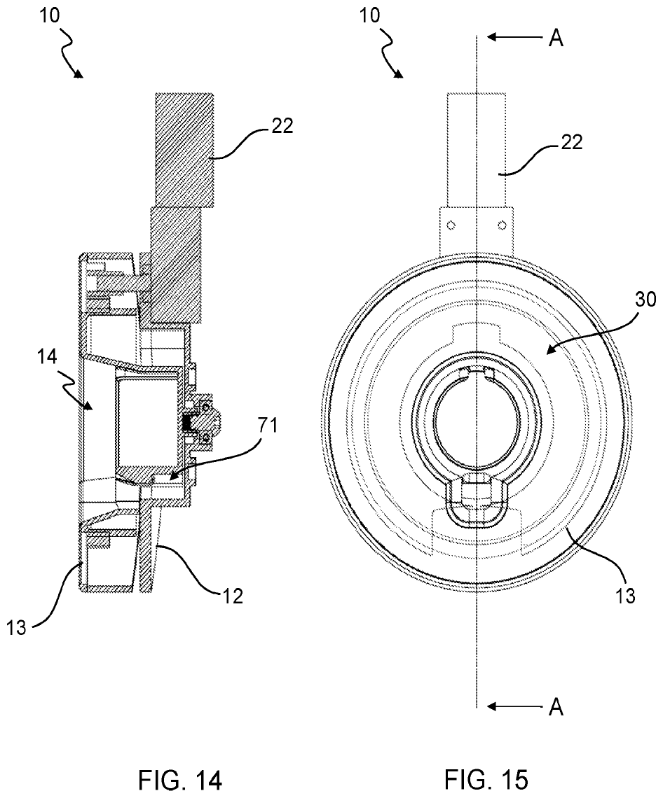

FIGS. 10 and 11 show a locking mechanism and associated cross-section in a locked position. FIGS. 12 and 13 show the locking mechanism and associated cross-section in an unlocked position with a charge handle 16. FIGS. 14 and 15 show the locking mechanism and associated cross-section in a locked position without a charge handle 16. In this embodiment, a locking mechanism works by rotating the charge handle 16 into a position where the latch 70 of the charge handle 16 can no longer be depressed to release it from the charge port 14. By stopping the actuation of the latch 70, the latch 70 is prevented from being unhooked from the detent in the charge handle 16.

In this instance, the locking mechanism works by providing an annular protrusion which has a cutout 71. The cutout aligns with the “unlocked” orientation of the charge handle 16. In any other orientation, the protrusion makes it that the latch 70 cannot be actuated to release the charge handle 16. This can eliminate the need for a separate actuator to enable locking/unlocking because locking is driven by the rotation/position. The system will rotate into the unlocked (i.e., user accessible) orientation when the user unlocks using an app, credit card, online, via phone, etc. After the user activates the system, the charge port 14 will automatically rotate into the accessible position. When the user is done charging, the user can place the charge handle 16 back into the charge port 14 and the charge port 14 can automatically sense that the charge handle 16 is in the charge port 14 via, for example, embedded magnets in the charge handle 16 and Hall Effect sensors embedded in the charge port 14 or another technique. After the charge handle 16 is sensed, the charge port 14 can rotate into the locked position automatically.

While disclosed with a physical lock, the locking functionality can be implemented with an electromechanical method, such as a solenoid-actuated piston, which can move an annular protrusion which prevents the latch 70 from be actuated, or actuates a protrusion which interfaces with some cavity or other mechanical features by which the charge handle 16 is prevented from being removed. In another instance, a rotational motor can also be used in place of a solenoid to similarly provide actuation to some feature which interfaces with the charge handle 16 to prevent it from being removed.

It will be understood that, while exemplary features of a method of operating the system have been described, such an arrangement is not to be construed as limiting the invention to such features. The method may be implemented in software, firmware, hardware, or a combination thereof. In one mode, the method is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. The steps of the method may be implemented by a server or computer in which the software modules reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s), i.e. of the control system, may be programmed to perform the functions of the method of operating the system and disclosed herein. The processor(s) is a hardware device for executing software, particularly software stored in memory. Processor(s) can be any custom made or commercially available processor, a primary processing unit (CPU), an auxiliary processor among several processors associated with a computer, a semiconductor-based microprocessor (in the form of a microchip or chip set), a macro-processor, or generally any device for executing software instructions.

Memory is associated with processor(s) and can include any one or a combination of volatile memory elements (e.g., random access memory (RAM, such as DRAM, SRAM, SDRAM, etc.) and non-volatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions in order to implement the functions of the modules. In the example of heretofore described, the software in memory includes the one or more components of the method and is executable on a suitable operating system (O/S).

The present disclosure may include components provided as a source program executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object-oriented programming language, which has classes of data and methods, or (b) a procedural programming language, which has routines, subroutines, and/or functions, for example but not limited to, C, C++, Pascal, Basic, Fortran, Cobol, Ped, Java, and Ada.

Additional details regarding, for example, the charge handle 16, the stationary body 12, or the charging process can be found in PCT/US22/25504, the appropriate sections of which are incorporated by reference.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a rotating front plate defining a charge port in an electric vehicle charging station;
a motor configured to provide powered rotational movement; and
a rotation assembly configured to rotate the rotating front plate relative to the electric vehicle charging station using the motor;
wherein the rotating front plate is configured to rotate between a first position and a second position; and
a charge plug having a charge handle, the charge plug configured to be retained in the charge port.

2. The system of claim 1, wherein the first position is 180° from the second position.

3. The system of claim 1, wherein the first position is configured to enable the storage of the charge plug, and wherein the second position is configured to enable use of the charge plug.

4. The system of claim 1, wherein the charge handle is locked in the first position and unlocked in the second position.

5. The system of claim 1, wherein the rotating front plate is disposed on a stationary body.

6. The system of claim 5, wherein the charge handle is configured to be positioned towards a top end of the stationary body when in the first position, and wherein the charge handle is configured to be positioned towards a bottom end of the stationary body when in the second position.

7. The system of claim 1, wherein the rotation assembly includes a bearing configured to allow for rotational movement of the rotating front plate.

8. The system of claim 1, further comprising a processor in electronic communication with the motor.

9. The system of claim 1, further comprising an encoder to determine rotation of the rotating front plate.

10. The system of claim 2, further comprising a sensor to determine when the charge handle is disposed in the charge port.

11. The system of claim 1, wherein the motor is configured to prevent rotation of the rotating front plate when not activated.

12. A method comprising:
rotating a rotating front plate and a charge handle of a charge plug in an electric vehicle charging station from a first position to a second position relative to the electric vehicle charging station using a rotation assembly and a motor; and
rotating the rotating front plate and the charge handle of the charge plug from the second position to the first position using the rotation assembly and the motor;
wherein the first position is configured to enable the storage of the charge plug, and wherein the second position is configured to enable use of the charge plug.

13. The method of claim 12, wherein the first position is 180° from the second position.

14. The method of claim 12, wherein the charge handle is locked in the first position and unlocked in the second position.

15. The method of claim 12, wherein a processor is configured to provide instructions to the motor.

16. The method of claim 15, wherein a user causes the rotation between the first position and the second position by sending a command to the processor with a communication device.

17. A non-transitory computer readable medium storing a program configured to instruct a processor to execute the method of claim 12.
